(19) United States
(12) Patent Application Publication
(10) Pub. No.: US 2022/0098061 A1
(43) Pub. Date: Mar. 31, 2022

(54) OZONE WATER VESSEL CAPABLE OF DIRECTLY ELECTROLYZING TAP WATER TO GENERATE OZONE WATER

(71) Applicant: Yantai United Ozonetec Corporation, Yantai (CN)

(72) Inventors: MING-YUNG HSU, Yantai (CN); WEI-CHUN HSU, Yantai (CN)

(21) Appl. No.: 17/033,924

(22) Filed: Sep. 28, 2020

(51) Int. Cl. C02F 1/467

(52) U.S. Cl. CPC C02F 1/4672; C02F 2001/46142

(57) ABSTRACT

An ozone water vessel capable of directly electrolyzing tap water to generate ozone water includes a vessel body, a sealing ring, and a vessel cover. A generator control board in a base includes a charging interface and a push button switch that are connected to a rechargeable lithium battery. The rechargeable lithium battery and the push button switch are connected to the generator control board. An ozone generator in the vessel body includes n generator anode and n+1 generator cathodes that are arranged by turns and connected to the generator control board. The generator anode is a coated titanium anode. The coated titanium anode includes a titanium substrate and a tin dioxide coating doped with ruthenium and nickel. In the tin dioxide coating doped with ruthenium and nickel, an atomic ratio of tin to ruthenium is 6:1-10:1, and an atomic ratio of ruthenium to nickel is 3:1-10:1.

### FIELD OF THE INVENTION

The present invention relates to an ozone water generator, and more particularly to an ozone water vessel capable of directly electrolyzing tap water to generate ozone water.

### BACKGROUND OF THE INVENTION

Generally, an ozone water generator that produces ozone by electrolyzing pure water uses lead dioxide as the material of its anode. Because lead dioxide is toxic and reduces catalytic activity, tap water cannot be used directly as electrolysis water, and only pure water can be used as electrolysis water to keep the stable performance of the generator. In many applications, electrolysis of pure water produces ozone gas, and then the ozone gas is mixed with ordinary water through mixing technology to produce ozone water. This increases the complexity of ozone equipment. Because the ozone water generator uses lead dioxide as the material of the anode, under the condition of turning on/off frequently, the surface of the lead dioxide is denatured and the catalytic activity is lost due to the reverse movement of hydrogen ions. Since only pure water can be used as electrolysis water, its use range and convenience are reduced greatly.

Accordingly, the inventor of the present invention has devoted himself based on his many years of practical experiences to solve these problems.

### SUMMARY OF THE INVENTION

The primary object of the present invention is to overcome the deficiencies of the prior art and provide an ozone water vessel capable of directly electrolyzing tap water to generate ozone water. The ozone water vessel comprises a vessel body. A sealing ring is threadedly connected to an upper end of the vessel body. The sealing ring is integrated with a vessel cover. A lower end of the vessel body is provided with a base. A generator control board and a rechargeable lithium battery are provided in the base. The generator control board is provided with a charging interface and a push button switch that are connected to the rechargeable lithium battery. The rechargeable lithium battery and the push button switch are connected to the generator control board. A bottom of a chamber in the vessel body is provided with an ozone generator capable of directly electrolyzing tap water. The ozone generator includes n generator anode and n+1 generator cathodes. n is a natural number ≥1. The generator anode and the generator cathodes are arranged by turns. The generator anode is a coated titanium anode. The coated titanium anode includes a titanium substrate and a tin dioxide coating doped with ruthenium and nickel. In the tin dioxide coating doped with ruthenium and nickel, an atomic ratio of tin to ruthenium is 6:1-10:1, and an atomic ratio of ruthenium to nickel is 3:1-10:1. The generator cathodes are one of metallic titanium cathodes and stainless steel cathodes. The generator anode and the generator cathode are connected to the generator control board.

Preferably, the vessel cover is in the form of a spray head.

The beneficial effect of the present invention is that it can directly electrolyze tap water to generate ozone water, therefore users more easily obtain ozone water. The anode is a coated titanium anode, which has stable performance and high catalytic activity, and can be used widely, and is portable, convenient and practical. The present invention can provide a detachable spray head to become a spray-type ozone water vessel that directly electrolyzes tap water to generate ozone water, thereby spraying ozone water for disinfection.

### BRIEF DESCRIPTION OF THE DRAWINGS

FIG. 1 is a schematic view according to a first embodiment of the present invention; and

FIG. 2 is a schematic view according to a second embodiment of the present invention.

### DETAILED DESCRIPTION OF THE PREFERRED EMBODIMENTS

Embodiments of the present invention will now be described, by way of example only, with reference to the accompanying drawings.

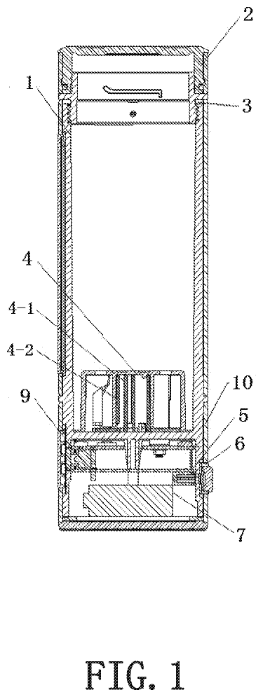

Referring to FIG. 1, the present invention discloses an ozone water vessel capable of directly electrolyzing tap water to generate ozone water. The ozone water vessel comprises a vessel body (1). A sealing ring (3) is threadedly connected to the upper end of the vessel body (1). The sealing ring (3) is integrated with a vessel cover (2). The lower end of the vessel body (1) is provided with a base (10). A generator control board (5) and a rechargeable lithium battery (7) are provided in the base (10). The generator control board (5) is provided with a charging interface (6) and a push button switch (9) that are connected to the rechargeable lithium battery (7). The rechargeable lithium battery (7) and the push button switch (9) are connected to the generator control board (5). The bottom of the chamber in the vessel body (1) is provided with an ozone generator (4) capable of directly electrolyzing tap water. The ozone generator (4) includes n generator anode (4-1) and n+1 generator cathodes (4-2). n is a natural number ≥1. The generator anode (4-1) and the generator cathodes (4-2) are arranged by turns. The generator anode (4-1) is a coated titanium anodes. The coated titanium anode includes a titanium substrate and a tin dioxide coating with a doping of ruthenium and nickel. In the tin dioxide coating doped with ruthenium and nickel, the atomic ratio of tin to ruthenium is 6:1-10:1, and the atomic ratio of ruthenium to nickel is 3:1-10:1. The material of the generator cathodes (4-2) is metallic titanium or stainless steel, preferably metallic titanium. Each generator anode (4-1) and each generator cathode (4-2) are connected to the generator control board (5). The generator control board (5) supplies constant current power to the ozone generator (4).

When in use, the push button switch (9) is pressed, the generator control board (5) supplies constant current power to the ozone generator (4), and the machine starts the ozone generator. When it reaches a predetermined time, the generator control board (5) automatically turns off the ozone generator, and the user can use ozone water.

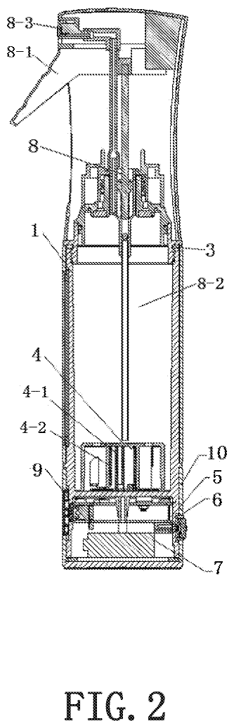

FIG. 2 illustrates a second embodiment of the present invention. The second embodiment is substantially similar to the first embodiment, and the difference is that a spray head (8) is provided, instead of the vessel cover (2).

When in use, the push button switch (9) is pressed, the generator control board (5) supplies constant current power to the ozone generator (4), and the machine starts the ozone generator. When it reaches a predetermined time, the generator control board (5) automatically turns off the ozone generator to complete the making of ozone water. The user presses a button (8-1) of the spray head (8), the external air enters the inside of the vessel body, and the ozone water generated in the vessel body (1) is sprayed out from a nozzle (8-3) of the spray head (8) through a tube (8-2) that extends to the bottom of the vessel body (1) for use.

What is claimed is:

1. An ozone water vessel capable of directly electrolyzing tap water to generate ozone water, comprising a vessel body, a sealing ring being threadedly connected to an upper end of the vessel body, the sealing ring being integrated with a vessel cover, a lower end of the vessel body being provided with a base, a generator control board and a rechargeable lithium battery being provided in the base; the generator control board being provided with a charging interface and a push button switch that are connected to the rechargeable lithium battery, the rechargeable lithium battery and the push button switch being connected to the generator control board; a bottom of a chamber in the vessel body being provided with an ozone generator capable of directly electrolyzing tap water, the ozone generator including n generator anode and n+1 generator cathodes, n being a natural number ≥1, the generator anode and the generator cathodes being arranged by turns, wherein the generator anode is a coated titanium anode, the coated titanium anode includes a titanium substrate and a tin dioxide coating doped with ruthenium and nickel, wherein in the tin dioxide coating with a doping of ruthenium and nickel, an atomic ratio of tin to ruthenium is 6:1-10:1, and an atomic ratio of ruthenium to nickel is 3:1-10:1; the generator cathodes are one of metallic titanium cathodes and stainless steel cathodes; the generator anode and the generator cathode are connected to the generator control board.

2. The ozone water vessel as claimed in claim 1, wherein the vessel cover is in the form of a spray head.

3. The ozone water vessel as claimed in claim 2, wherein the spray head includes a button, when the button is pressed, external air flows into the vessel body, and ozone water generated in the vessel body is sprayed out from a nozzle of the spray head through a tube that extends to a bottom of the vessel body.
